(19) United States
(12) Patent Application Publication
(10) Pub. No.: US 2006/0074811 A1
(43) Pub. Date: Apr. 6, 2006

(54) System and method for distributing content

(75) Inventors: Wyler Ferguson, Newcastle, CA (US); Chris Logsdon, Rocklin, CA (US)

Correspondence Address: Eric Ringer;Smith Frohwein Tempel Greenlee Blaha LLC, P.O. Box 88148, Atlanta, GA, 30356, US

(73) Assignee: Charismac Engineering, Inc., Auburn, CA (US)

(21) Appl. No.: 11/144,462

(22) Filed: Jun. 3, 2005

Related U.S. Application Data
(60) Provisional application No. 60/577,045, filed on Jun. 4, 2004.

(51) Int. Cl. G06Q 99/00

(52) U.S. Cl. 705/57

(57) ABSTRACT

A system and method providing copies of content is disclosed. The system includes a content distribution hub and a remote content distribution device. The content distribution hub receives some content and creates a recordable medium image of the content. The content distribution hub parses the recordable medium image of the content into data blocks and broadcasts the data blocks to the remote content distribution device. The remote content distribution device receives the data blocks and generates a second recordable medium image of the content using the received data blocks. The content distribution device is adapted to record a copy of the second recordable medium image of the content into a unit of recordable media.

### CROSS-REFERENCE TO RELATED APPLICATION

This application claims priority to copending U.S. provisional application entitled, “APPARATUS AND METHOD FOR SCALABLE DATA DISTRIBUTION AND REPLICATION,” having Ser. No. 60/577,045, filed Jun. 4, 2004, which is entirely incorporated herein by reference.

### TECHNICAL FIELD

The present invention is generally related to a system and method for distributing content and, more particularly, is related to a system and method for broadcasting content.

### BACKGROUND

Today, content such as audio content and/or video content is frequently converted into an electronic format and provided over a network to end-users. For example, music is frequently converted into a format such as MP3 and then sent over the internet to end-users. The trend for the future is that electronic content will be provided to end-users on a content-on-demand model, i.e., an end-user will contact a content provider and receive content upon the end-user's demand for the content.

Many of today's content distribution systems transmit content from a head-end or source to a specific address or end-user. Transmitting content can be a heavy strain on a content source. So frequently, content distribution systems include multiple sources of content so as to keep up with the load caused by the end-users demanding content. Another problem with current content distribution systems is the heavy load placed on the network. Sometimes the heavy load is the result of the content distribution system transmitting the same content over a network many times in response to end-user demand.

Thus, a heretofore-unaddressed need exists in the industry to address the aforementioned deficiencies and inadequacies.

### SUMMARY OF THE DISCLOSURE

Embodiments of the present invention provide a system and method for distributing content. Briefly described, in architecture, one embodiment of the system, among others, can be implemented as follows. The system includes a content distribution hub and a content distribution device. The content distribution hub and content distribution device are in communication via a network. The content distribution hub includes a content distribution module and a network interface device. The content distribution module is adapted to parse a first recordable medium image of the content into data blocks, and the network interface device is adapted to receive the blocks of data and broadcast the blocks of data over the network. The content distribution device includes a content management module and an output device. The content management module is configured to receive the broadcast of data blocks and generate a second recordable medium image of the content from the received data blocks. The output device is adapted to record a copy of the second recordable medium image of the content into a unit of recordable media.

Embodiments of the present invention can also be viewed as providing methods for distributing content. In this regard, one embodiment of such a method, among others, includes the steps of: creating a recordable medium image of the content; parsing the recordable medium image of the content into blocks of data; broadcasting the blocks of data; receiving blocks of data; re-creating the recordable medium image of the content from the received blocks of data; and recording a copy of the recordable medium image of the content onto a unit of recordable media.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a diagram of a content distribution system having a content distribution hub and a content distribution point.

FIG. 2 is a block diagram of a content distribution hub of FIG. 1.

FIG. 3 is a block diagram of memory in the content distribution hub.

FIG. 4 is a block diagram of a content distribution device of the content distribution point of FIG. 1.

FIG. 5 is a block diagram of memory in the content distribution device.

FIG. 6 is a flow chart depicting a method employed by the content distribution hub.

FIG. 7 is a flow chart depicting a method employed by the content distribution device.

FIG. 8 is a flow chart depicting a method employed by the content distribution hub of providing limited copying of content.

FIGS. 9A and 9B are flow charts depicting a method employed by the content distribution device of providing limited copying of content.

### DETAILED DESCRIPTION

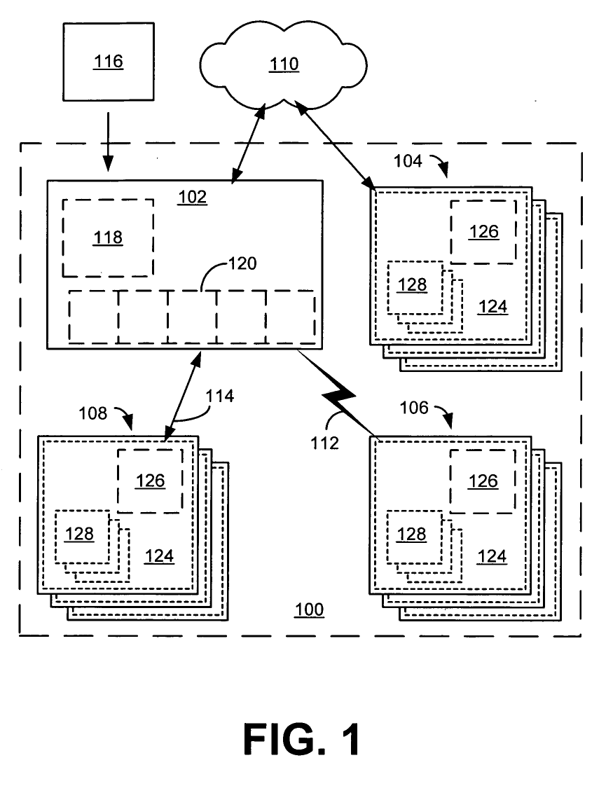

Referring to FIG. 1, in accordance with embodiments of the invention, an exemplary content distribution system (CDS) 100 includes a content distribution hub (CDH) 102 and a plurality of remote content distribution points (CDPs) 104, 106 and 108. The CDH 102 receives content 116 and creates a recordable medium image 118 of the content 116. The recordable medium image 118 is formatted such that it corresponds to a type of recordable medium, eg., hard drive image, RAID image, CD image, DVD image, tape image, etc. (The above mentioned types of images were provided for the sake of clarity and are intended as non-limiting examples.) The CDH 102 parses the recordable medium image 118 into data blocks 120 and broadcasts the data blocks 120 to the remote CDPs 104, 106 and 108.

Typically, the content 116 includes audio content or video content or multi-media content or written content, among other types of content. In some embodiments, the content 116 is received at the CDH 102 as “live” content, and the “live” content is recorded at the CDH 102. In other embodiments, the content 116 is provided to the CDH 102 as recorded content, and the recorded content is typically provided to the CDH 102 in a recorded medium. Non-limiting examples of recorded mediums include hard drives include RAID systems, tapes, and discs including CDs and DVDs. In other embodiments, the recorded medium is provided to the CDH 102 over a communication link.

In some embodiments, the CDH 102 is in communication with several CDPs 104, 106, and 108 over various communication links. For example, the CDH 102 is in communication with multiple CDPs 104 via a network such as, but not limited to, the Internet 110 and/or in communication with multiple CDPs 106 via a wireless communication link 112 and/or in communication with multiple CDPs 108 via a wire communication link 114. The CDH 102 and the multiple CDPs 104 communicate using well known Internet based protocols such as, but not limited to, Service Control Point (SCP), Secure File Transfer Protocol (SFTP), Peer-to-Peer (P2P), and File Transfer Protocol (FTP). Wireless and wire communication links are well known in the art, and consequently, the wireless communication link 112 and the wire communication link 114 and their protocols are not discussed in detail.

In FIG. 1, the CDH 102 is illustrated as being in communication with multiple CDPs 104 via the internet 110, multiple CDPs 106 via the wireless communication link 112, and multiple CDPs 108 via the wire communication link 114. In alternative embodiments, the CDH 102 might be in communication with a single CDP via a single communication link, or with multiple CDPs via a single type of communication link, or with multiple CDPs, where each CDP is connected to the CDH using a different type of communication link.

Each one of the CDPs includes a content distribution device (CDD) 124. Each one of the CDDs 124 is configured receive the data blocks 120 broadcasted from the CDH 102 and using the received data blocks 120 create a recordable medium image 126, which is a copy of the recordable medium image 118. Typically, the CDDs 124 store the recordable medium image 126 onto units of recordable medium 128, which can then be provided to users of the CDPs. Non-limiting examples of a unit of recordable media 128 include, but are not limited to, compact discs (CDs), digital video discs (DVDs), tapes, Random Access Memory (RAM), Flash RAM, and hard drives including Redundant Array of Inexpensive Disks (RAID) systems, etc.

It should be noted that in some embodiments, CDPs can be configured to provide copies of recordable medium images 126 without providing a unit of recordable media 128. For example, in one embodiment, a user of a CDP could bring a device and the recordable medium image could be transferred directly to the user's device. Alternatively, the user could provide the CDP with a unit of recordable media and the recordable medium image could be transferred to the unit of recordable media provided by the user.

Typically, the CDH 102 and the CDPs are in two-way communication. The CDH 102 transmits control messages to the CDPs and receives status messages from the CDPs. The control messages are typically job-orders authorizing one or more of the CDPs to distribute one or more copies of the recordable medium images 126. A status message from a given CDPs normally indicates the number of copies of recordable medium images 126 that the given CDP has distributed.

In one embodiment, the CDH 102 broadcasts the data packets 120 to the CDPs via a one-way in-band communication path and messages are communicated between the CDH 102 and the CDPs via a two-way out-of-band communication path. In other embodiments, the data packets 120 are broadcast in a two-way communication path.

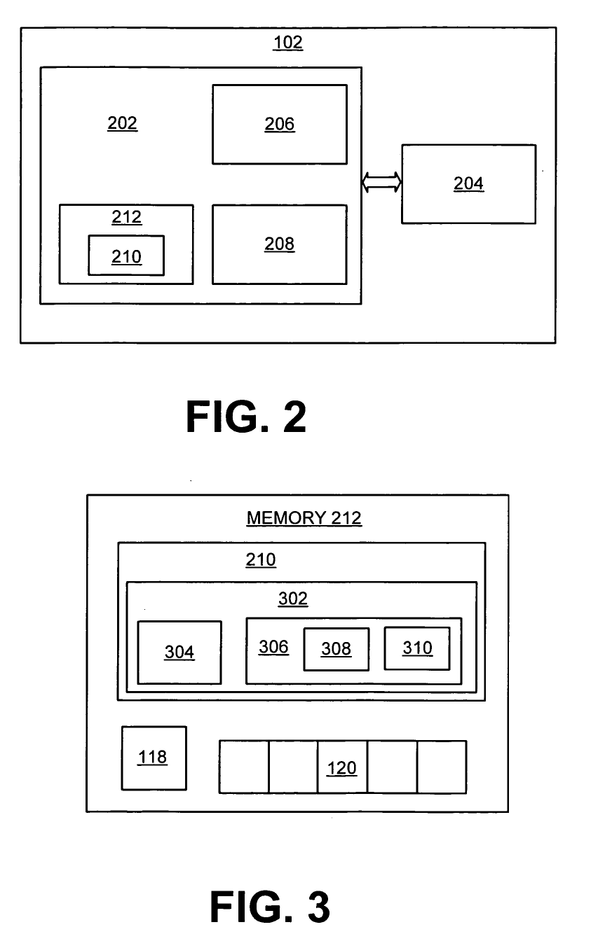

Referring to FIG. 2, in some embodiments, functionality of the CDH 102 is embodied in a computer system 202. The computer system 202 includes a security element 204, an input device 206, and network interface devices 208. The network interface devices 208 are typically network cards, which are well known in the art. The network interface devices interface with the internet 110, the wire communication link 112, and the wireless communication link 114. Among other things, the network interface devices are adapted to broadcast blocks of data.

The input device 206 receives the content 116. Typically, the input device 206 is a disc reader such as, but not limited to, a CD-R, DVD-R, DVD-R/CD-R. It should be noted that the input device can also be an input/output device such as, but not limited to, a CD-RW, DVD-RW, DVD-RW/CD-RW, etc. In some embodiments, the input device 206 is a card, a serial port, USB port, fire-wire port, or other port known to those skilled in the art. In other embodiments, the input device is adapted to receive an analog stream, and the analog stream is converted into one or more digital streams. It should be noted that in some situations the content 116 might be a compilation of content, and the content 116 can be received at the input device 206 directly from a mixing board. Furthermore, it should be noted that in some situations, content 116 can be received by the input device 206 and stored in a storage device (not shown) such as a hard drive.

The computer system 202 runs application software 210, which is stored in a memory 212 and which is described in detail hereinbelow, to provide, among other things, secure distribution of content 116. The application software 210 processes the content 116 received at the input port 206 and creates the recordable medium image 118.

Typically, the security element 204 is a dongle or a similar device having a memory. The security element 204 is coupled to the computer system 202 via an input/output port (not shown) using an interface such as, but not limited to, serial port or USB. In one embodiment, the security element interfaces with the application software 210 such that the application software will not properly execute unless there is an appropriate security element attached to the computer system 202. In one non-limiting example, the application software will not generate a recordable medium image 118 unless there is an appropriate security element attached to the computer system 202. In other non-limiting examples, failure to have an appropriate security element attached to the computer system 202 results in the application software failing to parse the recordable medium image into data blocks and/or broadcasting the data blocks 120.

In another embodiment, the application software 210 interfaces with the security element 204 to, among other things, initialize security elements for use at remote CDPs. The initialized security elements are then provided to selected CDPs so that the selected CDPs can distribute content.

FIG. 3 illustrates the memory 212 and the application software 210 in greater detail. In addition to having the application software 210 stored in the memory 212, the memory 212 includes the recordable medium image 118 and the data blocks 120. The application software 210 includes a master content control (MCC) module 302 comprising a master content management (MCM) module 304 and an auditor module 306.

Among other things, the MCM module 304 includes logic for receiving electronic content and creating the recordable medium image 118. The recordable medium image 118 is an image of electronic content that is to be stored in a predetermined medium. Those skilled in the art recognize that recordable medium images depend upon the medium upon which content is to be stored. In other words, for the same electronic content, the recordable medium image for a DVD is different from the recordable medium image for a CD. Typically, the MCM module 304 includes logic for creating the recordable medium image (or multiple images) according to different protocols such that the recordable medium image can be stored in one of a variety of recordable media such as, but not limited to, CD, DVD, tape, etc. The MCM module 304 also includes logic for parsing the recordable medium image 118 into the data blocks 120, which are then provided to the network interface card 210.

The auditor module 306 includes a job initiator module 308 and a job monitor module 310. The job initiator module 308 includes logic for, among other things, initializing security elements and creating job-orders. Typically, the job initiator module 308 provides an authentication code for a specific job and the authentication code is provided to the security element. Job-orders can be provided to the remote CDPs via the security elements or transmitted to the remote CDPs in system messages. Typically, a job-order specifies the maximum number of times that a CDP receiving the job-order can provide a copy of the recordable medium image 126.

Among other things, the job monitor module 310 receives status reports and process the status reports. Typically, the status reports are received from the remote CDPs, and the job monitoring module 310 uses the status reports to determine the number of copies of recordable medium images 126 that have been distributed. In some embodiments, the status reports are provided by the remote CDPs on a periodic or quasi-periodic basis and/or upon completion of a job-order and/or upon start-up of the CDPs.

In some embodiments, upon notification by the job monitoring module that a specific CDP has completed a job-order, i.e., the CDP has provided the maximum number of allowed copies of recordable medium image 126, the job initiator module 308 can generate a new job-order for the specific CDP. The new job-order is then transmitted to the specific CDP. The new job-order authorizes the specific CDP to provide more copies of the recordable medium images 126.

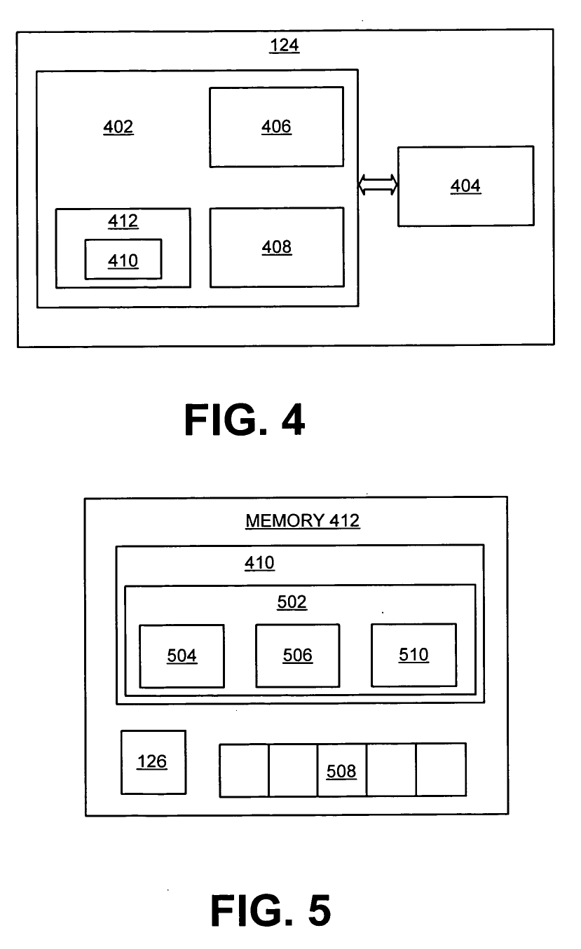

Typically, the CDDs 124 of the CDPs102, 104 and 106 are similarly configured. The CDD 124 illustrated in FIG. 4 is described as being of the CDP 102, and for the sake of simplicity, the CDDs 124 of the CDPs 104 and 106 are not illustrated. In some embodiments, functionality of the CDD 124 is embodied in a computer system 402. The computer system 402 includes a security element 404, an output device 406, and a network interface device 408. The network interface device 408 is typically a network card, which is well known in the art. The network interface device interfaces with the internet 110. (The network interface devices of the CDDs 124 of the CDPs 104 and 106 are configured to interface with the wire communication link 112 and the wireless communication link 114, respectively.)

Typically, the output device 406 provides copies of recordable medium images 126 to users of the CDD 124. Typically, the CDD 124 includes a recorder that records one or more copies of the recordable medium image 126 onto a unit of recordable media 128 and provides a user of the CDD 124 with a recorded unit of recordable media 128.

In some embodiments, the output device 406 is adapted to receive units of recordable media and record one or more copies of the recordable medium images 126 onto the received unit recordable media.

In some embodiments, the output device 406 is an interface coupling a user's device (not shown) to the CDD 124. The user's device is adapted to receive one or more copies of the recordable medium image 126. In other words, a copy of the recordable medium image 126 is transferred electronically from the CDD 124 to the user's device via the output device 406.

The computer system 402 runs application software 410, which is stored in a memory 412 and which is described in detail hereinbelow, to provide, among other things, secure distribution of copies of recordable medium image 126. The application software 410 receives data blocks 120, which are broadcast from the CDH 102, and creates the recordable medium image 126.

Typically, the security element 404 is a dongle or a similar device having a memory. The security element 404 is coupled to the computer system 402 via an input/output port (not shown) using an interface such as, but not limited to, serial port or USB. In one embodiment, the security element interfaces with the application software 410 such that the application software will not properly execute unless there is an appropriate security element attached to the computer system 402. In one non-limiting example, the application software 410 will not generate a recordable medium image 126 unless there is an appropriate security element 404 attached to the computer system 402.

FIG. 5 illustrates the memory 412 and the application software 410 in greater detail. In addition to having the application software 410 stored in the memory 412, the memory 412 includes the recordable medium image 126 and the data blocks 508, which correspond to data blocks 120 broadcast from the CDH 102. The application software 410 includes a client content control (CCC) module 502 comprising a client content management (CCM) module 504, a client-auditor module 506, and a security module 508.

Among other things, the CCM module 504 includes logic for receiving data blocks 508 creating the recordable medium image 126. The recordable medium image 126 is a copy of the recordable medium image 118. The CCM module 504 also includes logic for recording the recordable medium image 118 onto a unit of recordable media. It should be remembered that the unit of recordable media onto which the recordable medium image 118 is recorded can be provided by the user of the CCD or in a user's device or provided by the CCD 124. The CCM module 504 also includes the logic for verifying whether a copy of the recordable medium image 126 has been properly transferred or recorded into a unit of recordable media. In other words, after a copy of the recordable medium image 126 has been recorded into a unit of recordable media 128 (or into a user's device or a user provided unit of recordable media), the CCM module 504 verifies that the copy is correct, eg., the copy is readable, and notifies the client auditor module 506 that a copy of the recordable medium image 126 has been recorded onto a unit of recordable media 128 (or transferred to a user's device or recorded onto a unit of recordable media provided by the user.)

The client auditor module 506 includes the logic for monitoring job status, creating status messages, and limiting the distribution of copies of recordable medium image 126. The client auditor module 506 receives a job-order from the CDH 102. The job-order authorizes the CCD 124 to distribute a predetermined number of copies of the recordable medium image 126. The client auditor module 506 records the number of properly transferred/recorded copies of recordable medium images 126. Once the number of properly transferred/recorded copies of recordable medium images 126 equals the maximum number allowed by the job-order, the client auditor module 506 notifies the CCM module 504, which then stops transferring/recording copies of the recordable medium image 126.

In some embodiments, the client auditor module 506 generates a status message after properly transferred/recorded copy of the recordable medium image 126. The status message is transmitted to the CDH 102. Typically, the status message will include the current number of properly transferred/recorded copies of recordable medium images 126, and in some embodiments, the status message can include the number of available units of recordable medium 128. In addition, status messages can also be generated and transmitted after a specific system event such as the computer system 402 being booted-up. In some embodiments, status messages are generated on a periodic basis or on a quasi-periodic basis.

The security module 510 interfaces with the security element 404. Typically, the security module 510 uses information included in a job-order for determining whether the current security element 404 is associated with the current job-order. In the event that the current security element 404 is not associated with the current job-order, the CCM module 504 does not provide copies of the recordable medium image 126. In one embodiment, the CCM module 504 will not operate unless it receives positive confirmation from the security module 510 that the current security element 404 is associated with the current job-order. In another embodiment, the CCM module 504 will not operate once it receives notice from the security module 510 that the current security element 404 is not associated with the current job-order.

In one embodiment, the security module 510 interfaces security element 404 at various times such as the boot-up of the computer system 402, or after or during or prior to performing a task such as transferring/recording a copy of the recordable medium image. If the security module 510 fails to successfully interface with the security element 404, the application software 410 will cease providing copies of the recordable medium image 126. Because the security module 510 continues to interface with the security element 510 after the computer system 402 boots up, the security element 404 cannot be transferred to a different CDD 124 without disabling the current CCD 124.

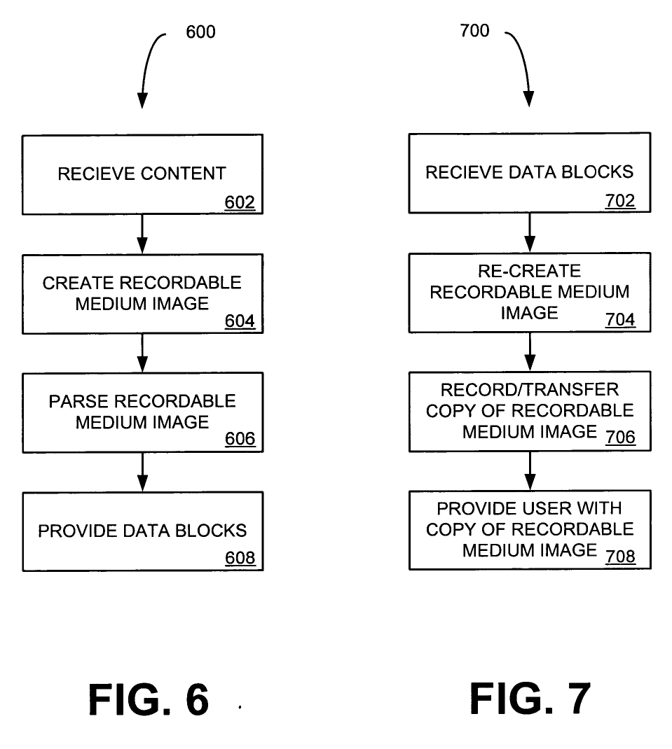

FIGS. 6-9 are flow charts that show the architecture, functionality, and operation of a possible implementation of the content distribution system 100. Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions and/or steps may be executed out of order from that shown or discussed, including substantially concurrently or in reverse order, depending on the functionality and/or step involved, as would be understood by those reasonably skilled in the art of the present invention

Referring to FIG. 6, exemplary steps 600 illustrate one embodiment of steps performed at the CDH 102. In step 602, the CDH 102 receives content 116. As previously mentioned, the content can be pre-recorded content or “live” content. In step 604, the CDH 102 creates a recordable medium image 118 of the received content. In one embodiment, the CDH 102 generates multiple types of recordable medium images of the content. For example, the CDH 102 may create a CD image of the content, a DVD image of the content, and a FLASH RAM image of the content, etc.

In step 606, the CDH 102 parses the recordable medium image (or the recordable medium images) into data blocks. In step 608, the data blocks are broadcast to the remote CDPs 104, 106 and 108.

Referring to FIG. 7, exemplary steps 700 illustrate one embodiment of steps performed at a remote CDPs. In step 702, the CDPs receive the data blocks from the CDH 102. In step 704, the CDH re-creates a second recordable medium image 126 from the received data blocks. The second recordable medium image 126 corresponds to the recordable medium image 118. They include the same content, and their images are for the same type of recordable medium, eg., CD, DVD, tape, etc.

In step 706, the CDP records or transfers a copy of the recordable medium image. In one embodiment, the CDP transfers a copy of the recordable medium image to a user's device, and typically, the user's device includes a memory into which the copy of the recordable medium image is recorded. For example, the user might have a personal computer, mobile telephone, personal digital assistant, music player, etc., that can interface with the CDP and receive a copy of the recordable medium image. In another embodiment, the CDP records a copy of the recordable medium image 126 onto a unit of recordable media. Normally, the unit of recordable media is provided by the CDP, but in alternative embodiments, the unit of recordable media can be provided by the user or third party.

In step 708, the copy of the recordable medium image is provided to the user of the CDP. Typically, the CDP provides the user with the copy of recordable medium image by providing the user with a unit of recordable media that has the copy of the recordable medium image recorded thereon.

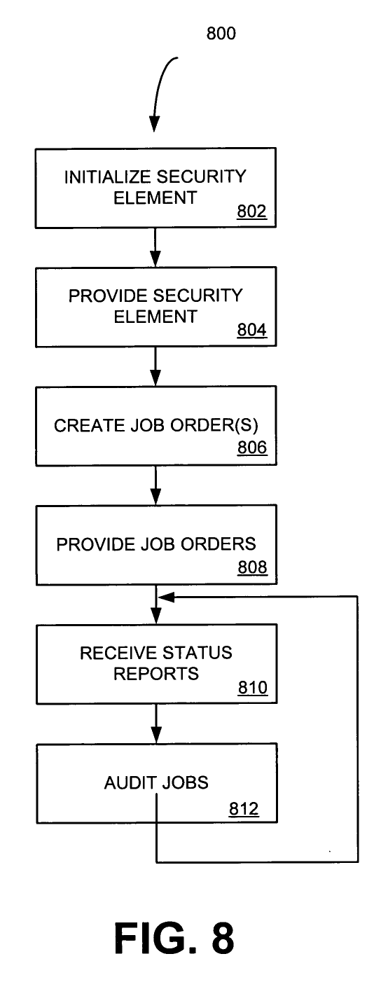

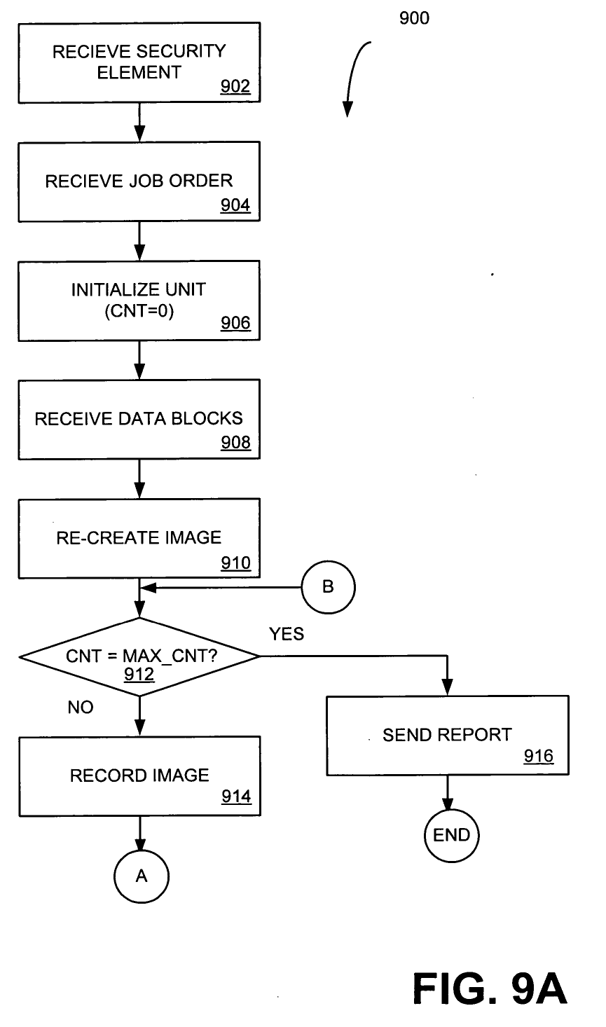

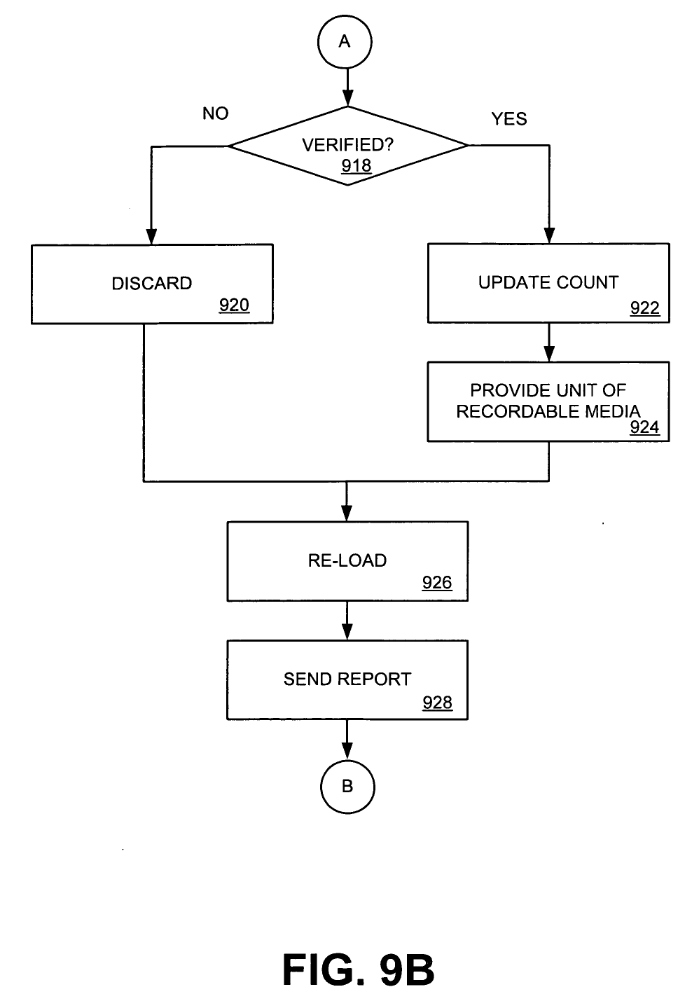

FIGS. 8 and 9A and 9B illustrate an exemplary method for limiting the distribution of copies of recordable medium images to a pre-determined maximum number of copies. The CDH 102 implements exemplary, non-limiting, steps 800, illustrated in FIG. 8, and the CDPs implement exemplary, non-limiting, steps 900, illustrated in FIGS. 9A and 9B.

In step 802, the CDH 102 initializes a security element. The initialization of the security element can include providing the security element with an authorization code. Typically, the authorization code is associated with a job-order. In some embodiments, the security elements are dongles or similar device. In step 804, the initialized security elements are provided to selected CDPs.

In step 806, job-orders are created. A global job-order for all of the selected CDPs can be generated or group job-orders, which are intended for a group of CDPs, or individual job-orders—each individual job-order is intended for a unique CDP. The job-orders defines the maximum number of copies of recordable medium images for that job-order that can be provided by any CDP receiving the job-order. Any CDP that has provided its maximum number of copies of recordable medium images can provide more copies after the CDP has received a new job-order.

In step 808, the job-orders are provided to the selected CDPs. Generally, the job-orders are transmitted from the CDH 102 to the CDPs 104, 106, 108 via their respective communication links. In some embodiments, job-orders might be included in the initialized security elements.

In step 810, the CDH 102 receives status reports from the CDPs. Typically, the status reports identifies the specific CDD 124 that has generated and sent the status report and reports on the number of copies of recordable medium images that the specific CDD 124 has distributed. The status report might also include other information such as the number of available/unused units of recordable media and/or the number of discarded units of recordable media. In some embodiments, the status report includes a serial number of the security element that was attached to the specific CCD that generated the status report when the status report was generated.

In step 812, the status reports are used for, among other things, auditing the CDDs 124 to make certain that they are providing no more than the allowed number of copies of recordable medium images. In some embodiments, once the job-order for a specific CDD 124 has expired, i.e., the specific CCD has provided its maximum number of copies for its current job-order, the CDH 102 can issue a new job-order to the specific CDD, thereby authorizing the specific CDD to provide more copies.

Referring to FIG. 9A, in step 902, a specific CDD 124 receives a security element. The security element is interfaced with the CDD 124 and carries an authorization code that is associated with a job-order. Without the authorization code, the CDD 124 cannot distribute copies of the recordable medium image.

In step 904, the specific CDD 124 receives a job-order. As previously described, the job-order specifies the maximum number (MAX_CNT) of copies of the recordable medium images that the specific CDD 124 can provide under the current job-order.

In step 906, the CDD 124 is initialized for the current job-order. The CDD 124 is adapted to count the number of copies of the recordable medium images that it provides and the counter is initialized to zero, i.e., CNT=0. In embodiments where the CDD 124 includes units of recordable media 128, a unit of recordable media can be loaded into the output device during the initialization.

In step 908, the CDD 124 receives data blocks from the CDH 102. In step 910, the CDD 124 re-creates the recordable medium image 126 from the received data blocks.

In step 912, the CDD 124 determines whether the number of copies of the recordable medium images that the specific CDD 124 has provided under the current job-order is equal to the maximum number (MAX_CNT). In other words, the CDD 124 determines whether it is authorized to provide more copies under the current job-order. If the CDD 124 is no longer authorized to provide more copies of the recordable medium image, then the CDD 124 proceeds to step 916 and sends a status report to the CDH 102, and the process for the current job-order ends.

On the other hand, if the CDD 124 is still authorized to provide copies of the recordable medium image, then the CDD 124 proceeds to step 914. In step 914, the CDD 124 records a copy of the recordable medium image. In some embodiments, the copy of the recordable medium image is recorded onto a unit of recordable media 128. In another embodiment, the copy of the recordable medium image is recorded onto a unit of recordable media provided by the user of the CDD 124, and in yet another embodiment, the copy of the recordable medium image is recorded onto a user's device such as, but not limited to, computer system, music player, mobile phone, personal digital assistant, etc.

In step 918 (see FIG. 9B), the CDD 124 verifies that the recorded copy is correct, eg., the recorded copy is readable. In one embodiment, the CDD 124 verifies the recorded copy by doing a check-sum operation on the recorded copy. If the recorded copy is verified, the process continues to step 922, otherwise the process continues at step 920.

In step 920, the CDD 124 discards the unit of recordable medium having the copy recorded therein. In embodiments where the copy is recorded in a user's device, the copy is deleted and step 926 is not performed.

Referring back to step 922, the count of provided copies is updated, and in step 924, the unit of recordable media having the verified copy of recordable medium image recorded therein is provided to the user of the CDD 124. In embodiments where the copy is recorded in a user's device, step 922 can be performed by disconnecting the interface between the user's device and the CDD.

In step 926, the output device 406 is re-loaded with another unit of recordable media 128. It should be remembered that in some embodiments, the user provides a unit of recordable media and that the steps 900 can be performed in different order. Thus, in some embodiments, the output device 406 is reloaded following a different step.

In step 928, the CDD 124 generates a status report, which is then transmitted to the CDH 102. It should be noted that the CDD 124 can generate and transmit multiple status reports during the exemplary steps 900. For example, a status report can be generated and transmitted during boot-up, prior to recording an image, and/or prior to providing a unit of recordable media.

Each of the above described programs/software, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the certain embodiments of the present invention includes embodying the functionality of the preferred embodiments of the present invention in logic embodied in hardware or software-configured mediums.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method of providing content, the method comprising the steps of:
(a) creating a recordable medium image of the content;
(b) parsing the recordable medium image of the content into blocks of data;
(c) broadcasting the blocks of data;
(d) receiving blocks of data;
(e) re-creating the recordable medium image of the content from the received blocks of data; and
(f) recording a copy of the recordable medium image of the content onto a unit of recordable media.

2. The method of claim 1, wherein step (c) includes broadcasting the data blocks to multiple remote locations.

3. The method of claim 1, wherein the unit of recordable media is a transferable recordable medium that can be transferred between multiple drives that are adapted to read the unit of recordable media.

4. The method of claim 1, further including the step of:
(g) prior to step (f), loading the unit of recordable media into a drive configured to record the copy of the recordable medium image of the content onto the unit of recordable media;
(h) after step (f), unloading the unit of recordable media from the drive; and
(i) after step (h), providing the unit of recordable media to a user.

5. The method of claim 4, further including the step of:
(j) repeating steps (f), (g), (h), and (i).

6. The method of claim 4, further including the steps of:
(j) prior to step (i), verifying that the unit of recordable media includes a readable copy of the recordable medium image of the content;
(k) discarding the unit of recordable media in response to failing to verify that the unit of recordable media includes a readable copy of the recordable media image of the content; and
(l) counting the number of verified copies of the recordable medium image of the content that have been provided.

7. The method of claim 1, further including the steps of:
(g) prior to step (f), interfacing with a security element, the security element having an authorization code authorizing the copying of the recordable medium image of the content onto units of recordable media;
(h) prior to step (f), determining whether authorization exists to perform step (f), wherein step (f) is only performed if authorization exists;
(i) verifying the unit of recordable media includes a readable copy of the recordable medium image of the content;
(j) counting the number of verified copies of the recordable medium image of the content that have been recorded into units of recordable media, wherein the determination of step (h) uses the number of verified copies.

8. The method of claim 7, further including the step of:
(k) receiving a job-order, wherein the job-order defines the maximum number of verified copies of the recordable medium image of the content can be recorded into units of recordable media.

9. The method of claim 7, further including the steps of:
(k) determining whether the security element is accessible; and
(l) responsive to determining the security element is not accessible, determining not to provide the unit of recordable media having the recordable medium image of the content recorded thereon.

10. A system for providing content, the system comprising:
a content distribution hub, the content distribution hub having a content distribution module and a network interface device, the content distribution module adapted to parse a first recordable medium image of the content into data blocks, the network interface device adapted to receive the blocks of data and broadcast the blocks of data over a network; and
a content distribution device in communication with the content distribution hub via the network, the content distribution device having a content management module and an output device, the content management module is configured to receive the broadcasted data blocks and generate a second recordable medium image of the content from the received data blocks, the output device is adapted to record a copy of the second recordable medium image of the content into a unit of recordable media.

11. The system of claim 10, wherein the system includes multiple content distribution devices in communication with the content distribution hub, wherein each content distribution device is configured to receive broadcasted data blocks and use the data blocks to generate the second recordable medium image of the content, and wherein each content distribution device is configured to copy the second recordable medium image of the content into a unit of recordable media.

12. The system of claim 10, wherein the content distribution device further includes a security module and a security element, wherein the security element includes an authorization code, wherein the security element uses the authorization code to determine whether the content distribution device is authorized to provide a copy of the recordable medium image of the content.

13. The system of claim 12, wherein the security module interfaces with the security element, wherein responsive to the security module failing to interface with the security element, the security module prevents the content distribution device from providing copies of the second recordable medium image of the content.

14. The system of claim 12, wherein the content distribution hub further includes an auditor module, the auditor module adapted to initialize the security element.

15. The system of claim 10, wherein the content distribution hub further includes an auditor module, the auditor module adapted to a generate job-order that specifies the maximum number of copies of the second recordable medium image of the content that the content distribution device can provide to a user of the content distribution device, wherein the content distribution device further includes a client-auditor module that uses the job-order to prevent the content distribution device from providing more copies of the second recordable medium image of the content than specified in the job-order.

16. The system of claim 15, wherein the client-auditor counts the number of copies of the second recordable medium image of the content that the content distribution device provides.

17. The system of claim 10, wherein the output device is adapted to provide the unit of recordable media to a user of the content distribution device.

18. The system of claim 10, wherein the output device is adapted to interface with an external device that includes the unit of recordable media.

19. The system of claim 10, wherein the first and second recordable medium images correspond to images for a transferable medium that is readable by multiple drives.

20. The system of claim 19, wherein the transferable medium selected from the group of consisting of compact discs, digital video discs, and magnetic tapes.
